(19) United States
(12) Patent Application Publication
(10) Pub. No.: US 2025/0251297 A1
(43) Pub. Date: Aug. 7, 2025

(54) METHANE EMISSION LEAK ATTRIBUTION

(71) Applicant: Schlumberger Technology Corporation, Sugar Land, TX (US)

(72) Inventors: Christopher Boucher, Cambridge, MA (US); Andrew J. Speck, Cambridge, MA (US); Lukasz Zielinski, Cambridge, MA (US); Manasi Doshi, Cambridge, MA (US)

(21) Appl. No.: 18/888,694

(22) Filed: Sep. 18, 2024

Related U.S. Application Data
(60) Provisional application No. 63/583,447, filed on Sep. 18, 2023.

(51) Int. Cl. G01M 3/04; G06T 7/70

(52) U.S. Cl. CPC G01M 3/04; G06T 7/70; G06T 2207/30232; G06T 2207/30244

(57) ABSTRACT

Systems and methods are described for determining leak attribution of a fugitive gas. In an example, a computing device receives a gas density image of a fugitive gas from a camera. The computing device identifies, based on the camera orientation and the estimated leak location within the camera's field of view, along with information about the camera installation and site geometry, the equipment unit or group of equipment units where the emission occurred.

### BACKGROUND

Calculating the emission rate of fugitive gases is an important part of detecting and determining the extent of leaks resulting from mining activity. These fugitive gas emissions contribute to greenhouse gas emissions that are harmful to the environment. Many fugitive emissions are the result of loss of well integrity through poorly sealed well casings due to geochemically unstable cement. This allows gas to escape through the well itself (known as surface casing vent flow) or via lateral migration along adjacent geological formations (known as gas migration).

Gas imagers scan a finite field of view (“FOV”) at a time. Some solutions include scanning pattern continuously and cyclically iterating through these predefined frames, acquiring images, and marking the images as positive if it sees an identifiable plume within the frame or negative if it does not. Each acquisition acts as a standalone observation. In solutions with recentering and zooming capabilities, upon plume detection, the imager may recenter on an estimated plume origin and acquire an additional frame at a predefined zoom (same as or different from the original zoom level). Even with optimally selected frames, such a scan cycle is prone to false positives from noise as well as large plumes spread across multiple frames, restricts attribution to sources within these predetermined frames, increases the likelihood of attributing an emission to an incorrect source, reduces the accuracy with which the duration of a leak can be calculated, limits leak rate quantification accuracy, and is susceptible to false negatives if the imager sees a portion of the plume but does not see an identifiable plume origin.

With rising concerns around gas emissions (especially greenhouses gases such as methane and carbon dioxide), it is crucial to accurately detect gas emissions along with their source, duration, and emission rate. As a result, a need exists for a gas imaging system that can adapt to real-time detections and changes.

The light detection and ranging (“LiDAR”) based gas monitoring system provides images of the integrated methane concentration, LiDAR range, and scattered light intensity within its field of view, together with an RGB image captured by a separate camera. However, employing human operators to identify the source of each methane leak by observing these images would present a bottleneck when operating methane LiDAR cameras at scale. Furthermore, the accuracy of the human operators would depend on their familiarity with each client site. Identifying the correct leak source from an image of one of several similar-looking pieces of equipment, such as one well head in a row of well heads, is particularly error-prone when the zoom level of each camera frame has been optimized to focus on one equipment unit, cutting off its surroundings, to improve the accuracy of leak rate quantification. Human operators are also affected by fatigue, cognitive biases, and lapses in concentration. As a result, a need exists for a gas imaging system for identifying the specific equipment or units of equipment as the leak source.

### SUMMARY

Examples described herein include systems and methods for an automatic and adaptive scanning method to efficiently scan for gas plumes originating from a facility using an imaging or LiDAR based gas monitoring system. In an example, a gas monitoring system can be coupled to a laser absorption spectroscopy with LiDAR. The gas monitoring system can detect methane emissions at oil and gas facilities using a combination of differential absorption spectroscopy and single photon detection of the scattered laser light.

In an example, systems and methods for optimizing the utilization of the imaging or LiDAR based gas monitoring system includes planning, commissioning, acquiring data automatically, interpreting the data, or extracting gas emission events from the data, or a combination thereof, to provide a complete lifecycle of a gas leak and a comprehensive understanding of the gas emissions. In another example, systems and methods for detecting the presence of a plume of gas includes using supervised machine learning to train a model to recognize which images contain plumes of gas and estimate corresponding rates of gas leakage based on the images.

In another example, when a gas emission is detected in an image, the computing device can determine the location with the highest gas concentration in the image. The LiDAR based gas monitoring system identifies equipment groups or individual units of equipment from which the gas is most likely to be leaking. The process of identifying the equipment units or equipment groups most likely to be the cause of the detected leak is called leak attribution. The information can then be used to promptly dispatch an appropriate repair crew.

In another example, is an algorithm for attribution of detected fugitive gas leaks to attribution subspaces defined for a client site. For each observation by the LiDAR camera, the camera orientation and the estimated leak location within the camera's field of view are uploaded to the LIDAR based gas monitoring system, where they are used together with information about the camera installation and site geometry to identify the equipment unit or group of equipment units where the emission occurred. They system may list multiple potential sources with an attribution confidence level for each.

Both the foregoing general description and the following detailed description are exemplary and explanatory only and are not restrictive of the examples, as claimed.

### BRIEF DESCRIPTION OF THE DRAWINGS

FIG. 1A is an illustration of an example attribution subspace.

FIG. 1B is an illustration of an example attribution subspace.

FIG. 1C is an illustration of an example attribution subspace.

FIG. 1D is an illustration of an example attribution subspace.

FIG. 2 is an illustration of an example method for attributing methane emissions to equipment.

FIG. 3 is an illustration of an example system for attributing methane emissions to equipment.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for calculating an emission rate of a fugitive gas based on a gas density image of the fugitive gas and identifying the source of the fugitive gas. In an example, a computing device receives a gas density image of a fugitive gas from a camera. The computing device determines the equipment unit or group of equipment units where the gas is detected.

The expectation of the client may be for a leak attribution algorithm to identify the specific unit of equipment that is leaking, or it may be sufficient to determine that some unit within a closely packed group of similar equipment is leaking. The client's expectations may depend on the number of equipment units, the spacing between them, and their distance from the camera.

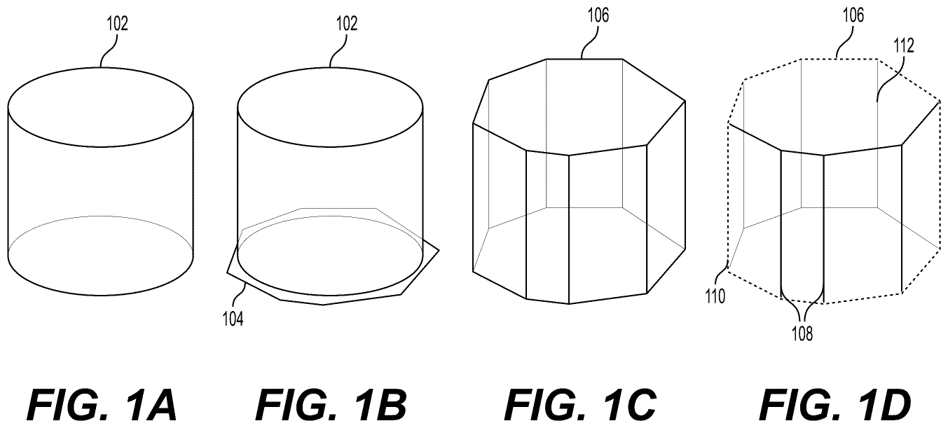

FIG. 1 is an illustration for creating an example attribution subspace. As used herein, the term “attribution subspace” (simply “subspace”) refers to a basic geometric unit to which a leak is attributed and may represent the spatial extents of either an equipment unit or equipment group. FIG. 1 includes subfigures FIGS. 1A, 1B, 1C, and 1D. FIG. 1A includes a specific unit of equipment 102. The equipment 102 can include multiple equipment units. The equipment 102 can be any type of equipment at a drilling site from which a methane leak may occur, such as a ventilation system, drilling equipment, mining equipment, a gas collection system, a processing facility, a sealed wellbore, a storage tank, or surface infrastructure.

FIG. 1B illustrates a polygon 104 on a two-dimensional (“2D”) plane that encloses the equipment 102 at ground level. The polygon 104 can be any polygon with three or more sides, such as a triangle or hexagon. Sides of the polygon can be of varying lengths. The polygon should fully enclose the equipment 102 but should not extend too far into the empty space surrounding it, or else the attribution algorithm can be biased to attribute more leaks to equipment closer to the camera.

FIG. 1C illustrates an attribution subspace 106. The subspace 106 is a polyhedron created by extending the sides of the polygon 104 upward above the height of the equipment 102 so that the equipment 102 is completely enclosed within the subspace 106.

The subspace 106 can have multiple types of edges as defined by a monitoring system, as shown in FIG. 1D. Interior edges 108 are defined as edges having two adjacent faces visible to a methane detection camera. Exterior edges 110 are defined as edges having one adjacent face visible to the camera and one hidden from it. Hidden edges 112 are defined as edges having two adjacent faces hidden from the camera. Each edge can be classified as interior, exterior, or hidden by taking the dot product of the outward normal vector of each adjacent face with the camera's line-of-sight vector and checking the sign.

A piece of equipment with uniform height, such as a tank, may be adequately represented by a single subspace. A piece of equipment with more significant variation in height, possibly because of the presence of tall vents or chimneys, may comprise several extruded polygons—for instance, a short, broad polygon combined with tall, narrow polygons. The extruded polygons can fully enclose the volume of the equipment in three dimensions (“3D”) without occupying too much of the empty space surrounding it.

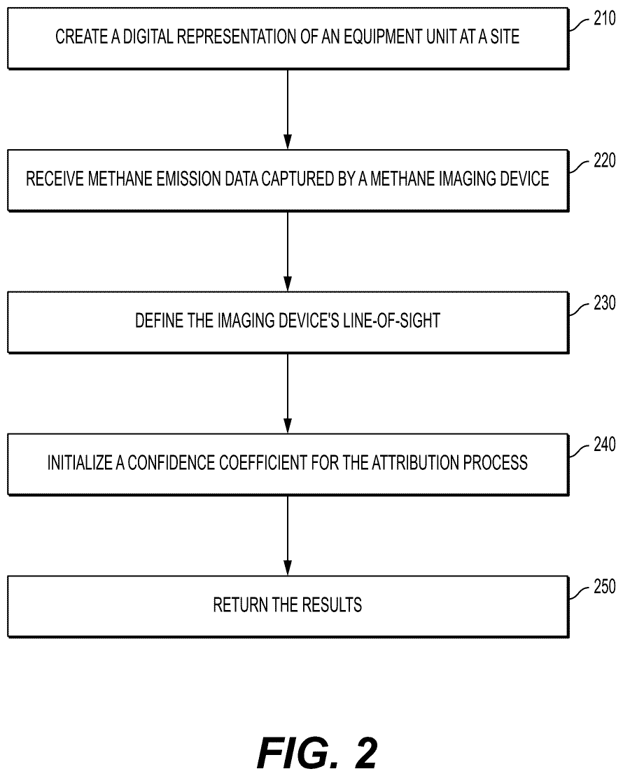

FIG. 2 is an illustration of an example method for attributing methane emissions to equipment. The successful deployment of continuous monitoring system can begin with installation and calibration of an imaging device, such as a LIDAR camera. The camera can be mounted on a tall mast or similar structure, and the camera's placement can be carefully selected to maximize coverage across the facility. This strategic positioning ensures that the camera can detect emissions from various sources, providing comprehensive monitoring of the site.

During installation, factors such as mast incline, potential misalignment, and the mechanical performance of the pan-tilt stage may introduce errors in the camera's orientation. To correct for these potential deviations, the camera can undergo a calibration process. This can involve aligning the camera with known reference points, verifying that it is accurately oriented, and confirming that its pan and tilt mechanisms are functioning correctly. In some cases, external sensors may be employed to continuously monitor the camera's orientation, allowing for real-time adjustments and maintaining alignment over time.

At stage 210, a computing device can create a digital representation of an equipment unit at a site. For example, the computing device can define attribution spaces for the equipment. These subspaces serve as digital representations of the physical equipment or groups of equipment at the monitoring site. Each piece of equipment or group of equipment is represented by a polygon that encloses its spatial extent, capturing critical details such as the latitude and longitude of each vertex. These polygons form the basis for determining the area from which a methane emission is likely to originate.

The polygons can fully enclose the equipment but not extend too far into the surrounding empty space, as this could lead to inaccuracies in leak attribution. For example, if a polygon is too large, the algorithm may wrongly attribute a leak to equipment closer to the camera simply because of the excess space included in the polygon. By precisely defining these subspaces, the system can more accurately distinguish between different potential leak sources, even in complex environments where multiple pieces of equipment are located close to one another.

To represent the equipment in three dimensions, these polygons are extruded into 3D solids by adding a height component, which corresponds to the actual height of the equipment. This extrusion creates a volumetric representation of each equipment unit or group, allowing the algorithm to consider not just the equipment's footprint but its full physical presence. For equipment with uniform height, such as tanks, a single extruded polygon may suffice. However, for equipment with varying heights, like structures with tall vents or chimneys, multiple extruded polygons may be required to capture the full geometry accurately.

These extruded 3D solids can play a critical role in the leak attribution process. By defining the spatial boundaries of each piece of equipment in three dimensions, the system can more effectively match detected methane emissions to their likely sources. This step ensures that the camera can provide precise and reliable leak attribution, helping operators quickly identify and respond to emissions with confidence. Through careful digital mapping of the site's equipment, the system is equipped to handle the complexities of real-world environments, where accurate leak detection is vital for safety and environmental protection.

At stage 220, the computing device can receive methane emission data captured by a methane imaging device. For example, the camera can employ an eye-safe infrared (“IR”) laser to scan the facility and detect methane through a process known as differential absorption spectroscopy. As the laser beam travels through the atmosphere, it encounters methane molecules that absorb specific wavelengths of light, causing changes in the intensity of the scattered light detected by the camera. This change in intensity is then measured using single photon detection technology, allowing the camera to accurately quantify the concentration of methane in the air. The camera's ability to capture detailed images of both the methane concentration and the scattered light, combined with its high-resolution red, blue, green (“RGB”) imaging, ensures that it can precisely locate and monitor methane emissions across the facility. The camera can upload this data to the computing device.

At stage 230, the computing device can define the imaging device's line-of-sight. This correlates the observed emissions with the predefined attribution subspaces representing various pieces of equipment on the site. The computing device first establishes the camera's line-of-sight based on its orientation, which includes its pan and tilt angles, and the estimated position of the methane leak within the camera's field of view. This involves projecting a virtual line from the camera to the emission point, providing a spatial reference for determining which equipment subspaces might be implicated.

To ensure the accuracy of this calculation, the computing device can consider potential sources of error that could affect the line-of-sight determination. These sources include mast incline, any misalignment of the camera during installation, and potential degradation of the mechanical performance of the pan-tilt stage. The device may use calibration parameters to correct for these errors and refine the line-of-sight calculation. Calibration involves periodically testing the camera's orientation by aiming it at known targets and adjusting for any discrepancies detected. This process ensures that the line-of-sight calculations remain precise and reliable.

With the line-of-sight accurately defined, the computing device then analyzes whether this line intersects with any of the 3D extruded polygons representing the equipment subspaces. If a direct intersection is identified, the computing device records the exact distance to the intersection point and calculates the minimum angle between the camera's line-of-sight and the edges of the intersected polygon. For instances where no direct intersection occurs, the computing device can assess the nearest edge of each polygon and calculate the angle between the line-of-sight and this edge. This comprehensive analysis enables the computing device to determine how closely the detected methane emissions align with the defined equipment subspaces, laying the groundwork for precise leak attribution in the next stages.

At stage 240, the computing device can attribute the methane leak with a subspace. This can involve a multi-step process. For example, the computing device can first aggregate all potential sources, which include both direct intersections and near misses identified during the line-of-sight analysis. Each potential source is assessed based on its distance from the camera and the angle at which the line-of-sight intersects or approaches the equipment subspaces.

The computing device can then sort these potential sources based on their distance from the camera, prioritizing those with the closest direct intersections first. This sorting ensures that the most likely sources of the leak, which are closest to the camera's line-of-sight, are considered before more distant or less likely sources. For direct intersections, the device records detailed metrics including the distance to the intersection point and the angle between the line-of-sight and the polygon's exterior edges. These metrics help determine the confidence level of each potential source in relation to the detected emissions.

In an example, the computing device can utilize an attribution algorithm to determine the source of the leak. The attribution algorithm can require the definition of a function, herein called a “miss function.” The miss function can have the following properties: The algorithm accepts one input argument that is a nonnegative real number. The input is specified in radians. It is monotonically non-increasing with a maximum value of 1 when the input argument is 0. It approaches zero for large values of the input argument. The exponential decay function exp(−kx), where k is a positive-valued coefficient with reciprocal angle units and x is the input argument, satisfies the requirements to be a miss function, although other functions may be used.

The attribution results can be further improved by defining a miss function that also accounts for average distance of the subspace from the camera, in which case a nearby subspace that the camera's line-of-sight misses by a certain angle may be treated differently than a more distance subspace that is missed by the same angle.

The computing device can calculate an attribution confidence for each potential source. This can involve normalizing the confidence values so that their total equals unity, which provides a clear measure of how likely each potential source is to be the origin of the methane leak. For example, the attribution algorithm can use a scalar coefficient, herein called the “confidence coefficient”. The value of the confidence coefficient can be initially set equal to 1 but can change during subspace attribution. The confidence coefficient is used to quantify the effect of nearby subspaces blocking the line-of-sight to more distant subspaces, making the attribution to those more distant subspaces less likely.

For every observation of a potential fugitive gas the attribution algorithm can proceed as follows: Check whether the camera's line of sight directly intersects the surface of each extruded subspace. If a direct intersection is detected, compute and store the distance to the intersection point and the minimum angle from the camera's line of sight to any exterior edge (e.g., an exterior edge 110 in FIG. 1). Keep all such direct intersections for the next step. If no direct intersection is found, compute and store the smallest angle from the camera's line of sight to any exterior edge. Also store the distance from the camera to point along the line-of-sight where it passes closest to this edge. If the minimum angle is less than a specified threshold, keep the near miss for the next step; otherwise, discard it.

Sort the direct intersections and near misses of all subspaces in ascending order of distance. Iterate over the direct intersections and near misses to compute the attribution confidence, starting with the closest one. For each direct intersection, the attribution confidence is equal to the value of the confidence coefficient. Then, the confidence coefficient is assigned a new value, equal to the product of its previous value with the value of the miss function, using the minimum angle between the line-of-sight and any exterior edge as input. For each near miss, the attribution confidence is equal to the product of the confidence coefficient with the value of the miss function, using the minimum angle between the line-of-sight and any exterior edge as input.

Normalize the attribution confidence values so that their sum equals unity. Sort the potential sources, including all direct intersections and near misses, in descending order of attribution confidence. For each potential source, return the subspace identifying information, type of potential source (direct intersection or near miss), distance, miss angle, and confidence.

By applying the miss function to adjust for factors such as the angle of near misses and the presence of obstructing equipment, the device refines the confidence levels. This ensures that the final attribution reflects a balance between direct evidence and the likelihood of obstructions affecting the detection.

The following is an example application of the attribution algorithm described above where the line-of-sight strikes the dead center of the extruded subspace representing Subspace A. The confidence in Subspace B is much lower, even though the line-of-sight directly intersects its subspace, because Subspace B is behind Subspace A. The miss function used is exp(−kx) with k=1/(1 degree). The line-of-sight has a direct intersection with Subspace A where the edge miss angle=3 degrees, followed by a direct intersection with Subspace B. The Subspace A unnormalized attribution confidence=1. In applying the miss formula, the new value of the confidence coefficient is exp(−3)=0.0498, which is the unnormalized attribution confidence for Subspace B. Subspace A is normalized as Confidence A=1/(1+0.0498), or about 95%; Subspace B is normalized as Confidence B=0.0498/(1+0.0498), or about 5%. The attribution confidence for Subspace A in this example is very high.

The following is an example application of the attribution algorithm where the line-of-sight directly intersects Subspace A but is close enough to the top or side of its extruded polygon that there is a reasonable chance of the leak coming from some equipment behind subspace A. The line-of-sight has a direct intersection with Subspace A where the edge miss angle=1 degree, followed by a direct intersection with Subspace B. The Subspace A unnormalized attribution confidence=1. In applying the miss formula, the new value of the confidence coefficient is exp(−1)=0.3679, which is the unnormalized attribution confidence for Subspace B. Subspace A is normalized as Confidence A=1/(1+0.3679), or about 73%; Subspace B is normalized as Confidence B=0.3679/(1+0.3679), or about 27%. In this example, the attribution confidence for Subspace A is still high, but not as high relative to Subspace B.

The following is an example application of the attribution algorithm where the line-of-sight does not directly intersect either subspace. The line-of-sight has a near miss with Subspace A where the edge miss angle=2 degrees, followed by a near miss with Subspace B where the edge miss angle=1 degree. The Subspace A unnormalized attribution confidence=exp(−2)=0.1353. The Subspace B unnormalized attribution confidence=exp(−1)=0.3679. Subspace A is normalized as Confidence A=0.1353/(0.1353+0.3679), or about 27%; Subspace B is normalized as Confidence B=0.3679/(0.1353+0.3679), or about 73%. The leak is attributed to Subspace B with higher confidence because the angle of the near miss is lower.

At stage 250, the computing device can return the results. For example, the result of stage 240 can be a ranked list of potential sources of the methane leak, each with an associated confidence level. This list enables operators to prioritize which equipment or equipment groups to inspect and repair, ensuring a prompt and effective response to methane emissions. The detailed sorting and confidence calculation provide a robust framework for leak attribution, helping to maintain high levels of accuracy and reliability in the methane monitoring process.

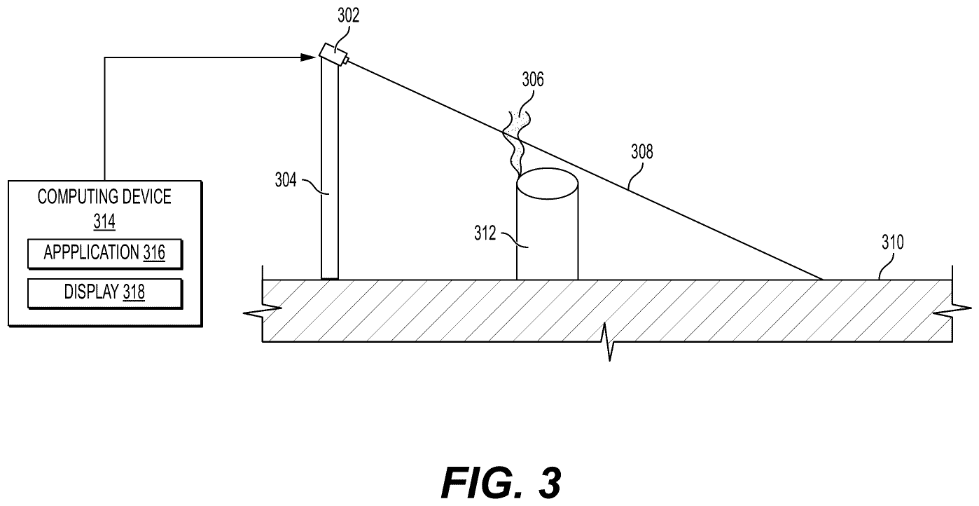

FIG. 3 is an illustration of an example system for attributing methane emissions to equipment. The system includes a camera 302, mounted on a tall mast 304. The camera 302 is aimed downward as it detects a methane leak 306 so that the laser beam 308 hits the ground 310 and some light can be scattered back to the camera. The camera 302 can be a LIDAR camera or any other imaging device that can detect methane. The orientation of the camera 302 can be controlled by a pan-tilt stage. The range of pan angles may be up to a full 360 degrees. The range of tilt angles may extend to a maximum of 90 degrees (directly downward) and to a minimum of −90 degrees (directly upward) with the horizon at zero degrees. Because the quantification of methane density requires a return path for scattered radiation, the camera 302 can be mounted on a tall mast 304 so that the infrared laser 308 it emits is scattered by the ground 310 or other surfaces as it scans the equipment 312 at a facility, as illustrated in FIG. 1. The most frequently used range of tilt angles for emissions monitoring is between zero and 90 degrees.

The camera 302 captures real-time imaging data, including measurements of methane concentration, LiDAR range, scattered light intensity, and RGB images, and transmits this data to a connected computing device 314. This data transmission can be facilitated through a secure, high-bandwidth communication link that ensures the integrity and speed of data transfer. The computing device 314 can be any processor-based device, such as a computer, tablet, cell phone, edge server, or server in a cloud-based computing system.

Once the data is received by the computing device 314, an application 316 running on the device 314 processes the imaging data to perform the necessary steps for methane leak detection and attribution. The application 316 first estimates the location of the methane emissions within the camera's field of view and then projects a line-of-sight to the detected emissions. The application 316 continues by determining intersections with predefined attribution subspaces, calculating attribution confidence levels, and sorting the potential sources. The computing device 314 also includes a display 318 that allows the processed data and analysis results, such as the identified leak sources and their confidence levels, to be visually presented to operators. This display 318 enables real-time monitoring and decision-making, ensuring that the detected methane emissions can be promptly addressed.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for attributing fugitive gas emissions, comprising:
receiving imaging data from a methane detection camera;
estimating a location of the fugitive gas emissions within a field of view of the camera based on the received imaging data and an orientation of the camera;
projecting a line-of-sight from the camera to the estimated location of the methane emissions, wherein the line-of-sight is determined based on the orientation of the camera and the distribution of the methane concentration within the field of view;
determining whether the line-of-sight intersects with one or more predefined attribution subspaces representing equipment at the monitoring site;
calculating an attribution confidence level for each attribution subspace, the calculation comprising; and
attributing the fugitive gas emissions to an equipment or group of equipment with the highest attribution confidence level.

2. The method of claim 1, wherein each attribution subspace is defined as one of:
a three-dimensional (“3D”) polygon that encloses the equipment;
a 3D Computer Aided Design (“CAD”) model of the equipment; and
a 3D object created from a light detection and ranging (“LiDAR”) scan of the equipment.

3. The method of claim 1, wherein calculating the attribution confidence level for each attribution subspace comprises:
identifying direct intersections between the line-of-sight and the attribution subspaces;
identifying near misses between the line-of-sight and the attribution subspaces based on proximity; and
applying a miss function to adjust the confidence level based on the angle of intersection or near miss.

4. The method of claim 3, wherein the miss function used in the calculation of the attribution confidence level is an exponential decay function of the form exp(−kx), where k is a positive coefficient and x is the angle between the line-of-sight and an exterior edge of the attribution subspace.

5. The method of claim 3, further comprising adjusting the attribution confidence level based on the distance between the camera and each attribution subspace, with closer subspaces receiving higher confidence levels for the same miss angle.

6. The method of claim 1, wherein the attribution subspaces are defined as extruded polygons, each having a height corresponding to the equipment's dimensions, and wherein the extrusion is formed by translating a base polygon upward by a specified height.

7. The method of claim 1, further comprising displaying the attribution subspaces and their corresponding attribution confidence levels on a user interface, allowing an operator to visually identify and respond to the most probable source of the methane emissions.

8. A non-transitory, computer-readable medium containing instructions that, when executed by a hardware-based processor, causes the processor to perform stages for attributing fugitive gas emissions, comprising:
receiving imaging data from a methane detection camera;
estimating a location of the fugitive gas emissions within a field of view of the camera based on the received imaging data and an orientation of the camera;
projecting a line-of-sight from the camera to the estimated location of the methane emissions, wherein the line-of-sight is determined based on the orientation of the camera and the distribution of the methane concentration within the field of view;
determining whether the line-of-sight intersects with one or more predefined attribution subspaces representing equipment at the monitoring site;
calculating an attribution confidence level for each attribution subspace, the calculation comprising; and
attributing the fugitive gas emissions to an equipment or group of equipment with the highest attribution confidence level.

9. The non-transitory, computer-readable medium of claim 8, wherein each attribution subspace is defined as one of:
a three-dimensional (“3D”) polygon that encloses the equipment;
a 3D Computer Aided Design (“CAD”) model of the equipment; and
a 3D object created from a light detection and ranging (“LiDAR”) scan of the equipment.

10. The non-transitory, computer-readable medium of claim 8, wherein calculating the attribution confidence level for each attribution subspace comprises:
identifying direct intersections between the line-of-sight and the attribution subspaces;
identifying near misses between the line-of-sight and the attribution subspaces based on proximity; and
applying a miss function to adjust the confidence level based on the angle of intersection or near miss.

11. The non-transitory, computer-readable medium of claim 10, wherein the miss function used in the calculation of the attribution confidence level is an exponential decay function of the form exp(−kx), where k is a positive coefficient and x is the angle between the line-of-sight and an exterior edge of the attribution subspace.

12. The non-transitory, computer-readable medium of claim 10, the stages further comprising adjusting the attribution confidence level based on the distance between the camera and each attribution subspace, with closer subspaces receiving higher confidence levels for the same miss angle.

13. The non-transitory, computer-readable medium of claim 8, wherein the attribution subspaces are defined as extruded polygons, each having a height corresponding to the equipment's dimensions, and wherein the extrusion is formed by translating a base polygon upward by a specified height.

14. The non-transitory, computer-readable medium of claim 8, the stages further comprising displaying the attribution subspaces and their corresponding attribution confidence levels on a user interface, allowing an operator to visually identify and respond to the most probable source of the methane emissions.

15. A system for maintaining consistent results in an artificial intelligence (“AI”) pipeline, comprising:
a memory storage including a non-transitory, computer-readable medium comprising instructions; and
at least one hardware-based processor that executes the instructions to carry out stages comprising:
receiving imaging data from a methane detection camera;
estimating a location of the fugitive gas emissions within a field of view of the camera based on the received imaging data and an orientation of the camera;
projecting a line-of-sight from the camera to the estimated location of the methane emissions, wherein the line-of-sight is determined based on the orientation of the camera and the distribution of the methane concentration within the field of view;
determining whether the line-of-sight intersects with one or more predefined attribution subspaces representing equipment at the monitoring site;
calculating an attribution confidence level for each attribution subspace, the calculation comprising; and
attributing the fugitive gas emissions to an equipment or group of equipment with the highest attribution confidence level.

16. The system of claim 15, wherein each attribution subspace is defined as one of:
a three-dimensional (“3D”) polygon that encloses the equipment;
a 3D Computer Aided Design (“CAD”) model of the equipment; and
a 3D object created from a light detection and ranging (“LiDAR”) scan of the equipment.

17. The system of claim 15, wherein calculating the attribution confidence level for each attribution subspace comprises:
identifying direct intersections between the line-of-sight and the attribution subspaces;
identifying near misses between the line-of-sight and the attribution subspaces based on proximity; and
applying a miss function to adjust the confidence level based on the angle of intersection or near miss.

18. The system of claim 17, wherein the miss function used in the calculation of the attribution confidence level is an exponential decay function of the form exp(−kx), where k is a positive coefficient and x is the angle between the line-of-sight and an exterior edge of the attribution subspace.

19. The system of claim 17, the stages further comprising adjusting the attribution confidence level based on the distance between the camera and each attribution subspace, with closer subspaces receiving higher confidence levels for the same miss angle.

20. The system of claim 15, wherein the attribution subspaces are defined as extruded polygons, each having a height corresponding to the equipment's dimensions, and wherein the extrusion is formed by translating a base polygon upward by a specified height.
